(19) United States
(12) Patent Application Publication
(10) Pub. No.: US 2026/0296352 A1
(43) Pub. Date: Oct. 1, 2026

(54) VEHICLE

(71) Applicant: HONDA MOTOR CO., LTD., Tokyo (JP)

(72) Inventors: Yoshiyuki Sato, Tokyo (JP); Youhei Sakuma, Tokyo (JP)

(21) Appl. No.: 19/550,647

(22) Filed: Feb. 26, 2026

(30) Foreign Application Priority Data
Mar. 28, 2025 (JP) 2025-056979

(51) Int. Cl. B60R 21/06; E06B 9/52

(52) U.S. Cl. CPC B60R 21/06; E06B 9/52; E06B 2009/527

(57) ABSTRACT

A vehicle includes a vehicle body frame, a hinge bracket, a door swingably supported by the vehicle body frame via the hinge bracket, and a door net that covers a cabin space from above the door. The door net has a substantially triangular shape, and includes door net attachment portions, which are respectively provided at corner portions of the door net. One of the door net attachment portions is attached to the door, remaining two of the door net attachment portions are swingably attached to the vehicle body frame, and one of the door net attachment portions swingably attached to the vehicle body frame is attached to the hinge bracket.

### INCORPORATION BY REFERENCE

The present application claims priority under 35 U.S.C.§119 to Japanese Patent Application No.2025-056979 filed on Mar. 28, 2025. The content of the application is incorporated herein by reference in its entirety.

### BACKGROUND

### TECHNICAL FIELD

The present invention relates to a vehicle.

### Related Art

A saddle-ride vehicle in which two or more seats are provided side by side on the left and right, a so-called side-by-side multi utility vehicle (MUV) is conventionally known as a vehicle (see, for example, US 8,123,279). In the vehicle described in US 8,123,279, opening and closing a door enables an occupant to get in or out of a cabin space, a door net that closes an upper side of the door is provided in a frame, and thus vehicle has protection performance for the occupant during traveling. In the technique described in US 8,123,279, when the occupant gets in or out, a part of a door net is detached from the frame to open and close the door. In addition, in the technique described in US 8,123,279, the door net is attached to the frame so that the tension of the door net is appropriately adjustable.

### SUMMARY

In the technique described in US 8,123,279, however, it is necessary to attach the door net to the vehicle body frame in order for the door net to function, thereby leading to a problem in that complicated operation tends to be necessitated. In addition, in opening and closing the door, repeatedly attaching and detaching the door net may change its shape (tension) of the door net.

The present invention has been made in view of the above circumstances, and an object of the present invention is to provide a vehicle in which a door net is provided so that a shape change hardly occurs, while getting in or out of a cabin space is enabled with a simple operation.

A vehicle includes: a vehicle body frame that defines a cabin space; a hinge bracket provided on the vehicle body frame; a door swingably supported by the vehicle body frame via the hinge bracket; and a door net, which is attached to the vehicle body frame, and which covers the cabin space from above the door, in which the door net has a substantially triangular shape in a vehicle side view, and includes three door net attachment portions, which are respectively provided at corner portions of the door net, and which are attached to a vehicle body, one of the three door net attachment portions is attached to the door, and remaining two door net attachment portions of the three door net attachment portions are swingably attached to the vehicle body frame, and one of the remaining two door net attachment portions swingably attached to the vehicle body frame is attached to the hinge bracket.

It becomes possible to provide a vehicle in which a door net is provided so that a shape change hardly occurs, while getting in or out of a cabin space is enabled with a simple operation.

### BRIEF DESCRIPTION OF DRAWINGS

FIG. 1 is a left side view of an irregular ground travel vehicle according to a first embodiment;

FIG. 2 is a left side view illustrating a peripheral portion of a hinge bracket according to the first embodiment;

FIG. 3 is an explanatory view of an operation unit of a left front door;

FIG. 4 is a left side view illustrating a peripheral portion of a hinge stay portion on an upper side of the hinge bracket according to the first embodiment;

FIG. 5 is a perspective view of a peripheral portion of the hinge stay portion on the upper side of the hinge bracket according to the first embodiment when viewed from left rear;

FIG. 6 is a plan view illustrating a peripheral portion of the hinge stay portion on the upper side of the hinge bracket according to the first embodiment;

FIG. 7 is a cross-sectional view taken along line VII-VII in FIG. 6;

FIG. 8 is a left side view of an irregular ground travel vehicle according to a second embodiment;

FIG. 9 is a left side view illustrating a peripheral portion of a hinge stay portion on an upper side of a hinge bracket according to a third embodiment;

FIG. 10 is a plan view illustrating the peripheral portion of the hinge stay portion on the upper side of the hinge bracket according to the third embodiment;

FIG. 11 is a cross-sectional view taken along line XI-XI in FIG. 10;

FIG. 12 is a cross-sectional view schematically illustrating a peripheral portion of a hinge stay portion on an upper side of a hinge bracket according to a fourth embodiment; and

FIG. 13 is a cross-sectional view schematically illustrating a peripheral portion of a hinge stay portion on an upper side of a hinge bracket according to a fifth embodiment.

### DETAILED DESCRIPTION

Hereinafter, embodiments of the present invention will be described with reference to the drawings. Note that, in the description, directions such as front, rear, left, right, up, and down are identical to directions with respect to a vehicle body, unless otherwise specified. In the drawings, reference sign FR denotes the front side of the vehicle body, reference sign UP denotes the upper side of the vehicle body, and reference sign LH denotes the left side of the vehicle body.

### First Embodiment

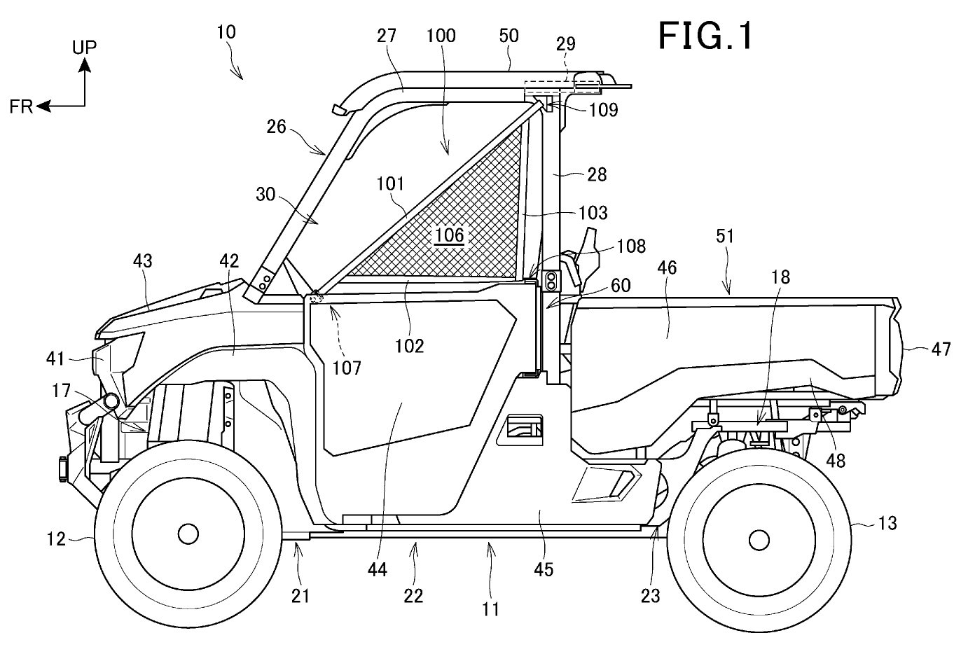

FIG. 1 is a left side view of an irregular ground travel vehicle 10 according to a first embodiment.

The irregular ground travel vehicle 10, as an example of the vehicle, is a side-by-side MUV. The irregular ground travel vehicle 10 includes: a vehicle body frame 11; a pair of left and right front wheels 12, which are supported by a front portion of the vehicle body frame 11; a pair of left and right rear wheels 13, which are supported by a rear portion of the vehicle body frame 11; and a power unit (not illustrated) disposed in a lower portion close to the rear of the vehicle body. The irregular ground travel vehicle 10 travels using driving force supplied by the power unit to the front wheels 12 and the rear wheels 13.

The vehicle body frame 11 includes: a front frame 21; a center frame 22, which is connected with a rear portion of the front frame 21; and a rear frame 23, which is connected with a rear portion of the center frame 22. The vehicle body frame 11 also includes the front frame 21, and an upper frame 26, which is attached to extend upward from the center frame 22.

The front wheels 12 are supported by the front frame 21 via a front suspension 17.

The rear wheels 13 are supported by the rear frame 23 via a rear suspension 18.

In a vehicle side view, the upper frame 26 includes: a pair of left and right front pillars 27, which extend rearward and upward from a rear upper portion of the front frame 21 and then extend rearward; a pair of left and right center pillars 28, which respectively extend upward from the center frame 22 and are then connected with rear end portions of the front pillars 27; and a cross frame 29, which connects between rear end portions of the left and right center pillars 28. A roof 50 having a plate shape is attached to the upper side of the upper frame 26.

A space surrounded by the front frame 21, the center frame 22, and the upper frame 26 forms a cabin space 30 which an occupant gets in.

Seats (not illustrated), on which a driver and a passenger are respectively seated, are disposed inside the cabin space 30. The seats are arranged side by side on the left and right. An operation system such as a steering wheel (not illustrated) to be operated by the driver is disposed inside the cabin space 30.

The irregular ground travel vehicle 10 includes: a front cover 41, which is provided at a front end portion, and which covers a front end of the irregular ground travel vehicle 10; a front fender 42, which is provided at a rear portion of the front cover 41, and which covers the rear of the front wheel 12 from above; a front upper cover 43, which is provided above the front fender 42, and which covers a front upper portion of the irregular ground travel vehicle 10; and a front door (door) 44, which is disposed on the rear of the front fender 42, and which is provided to be openable and closable via a hinge bracket 60 at a rear end portion.

The irregular ground travel vehicle 10 also includes: a side cover 45, which is disposed on lower rear of the front door 44, and which covers a lateral portion of the irregular ground travel vehicle 10; a rear side cover 46, which is disposed upper rear of the side cover 45; a rear cover 47, which covers a space between the left and right rear side covers 46 from the rear; and a rear fender 48, which is provided below the rear side covers 46, and which covers the rear wheel 13 from above. The rear side covers 46 and the rear cover 47 cover a cargo bed 51 from the outside. The cargo bed 51 is supported by the rear frame 23. The cargo bed 51 is used as a space for placing a cargo. By disposing a rear seat on the cargo bed 51, another occupant may be seated.

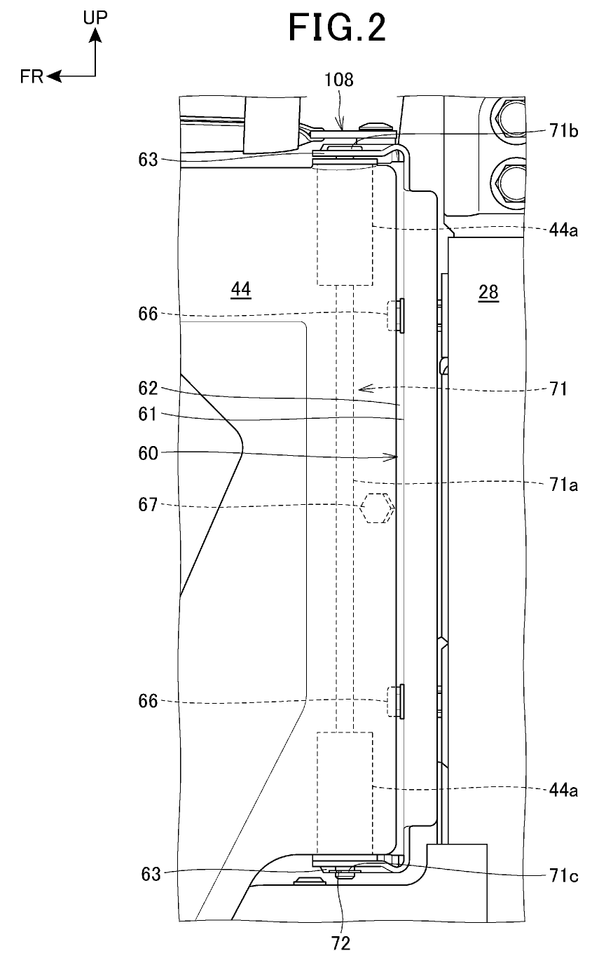

FIG. 2 is a left side view illustrating a peripheral portion of the hinge bracket 60 according to the first embodiment.

The front door 44 is swingably supported by the vehicle body frame 11. The hinge bracket 60, which extends in the up-down direction, is supported by the vehicle body frame 11. The hinge bracket 60 includes: a base portion 61, which extends in the up-down direction; an extension portion 62, which extends forward from an inner end in the vehicle width direction of the base portion 61; and hinge stay portions 63, which are respectively provided at both upper and lower ends of the base portion 61, and each of which has a thickness in the up-down direction. According to the present embodiment, the hinge stay portions 63 each have a plate shape that bends forward from both upper and lower ends of the base portion 61.

In the hinge bracket 60, the base portion 61 is fixed to the center pillar 28 of the vehicle body frame 11 with a bolt (fixing member) 66, which extends in the front-rear direction. The extension portion 62 is also fixed to the center frame 22 of the vehicle body frame 11 with a bolt 67, which extends inward in the vehicle width direction.

A rear end portion of the front door 44 is disposed between the upper and lower hinge stay portions 63. In addition, a hinge pin (a swing shaft) 71 is supported between the upper and lower hinge stay portions 63. The front door 44 is swingably supported by the vehicle body frame 11 via the hinge pin 71.

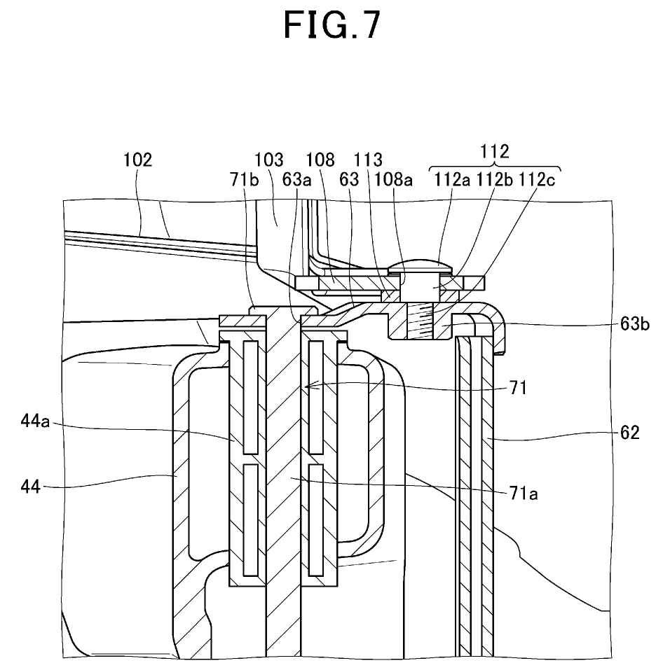

Specifically, the hinge pin 71 includes a shaft portion 71a, which extends in the up-down direction. A large-diameter portion 71b having a larger diameter than the shaft portion 71a is formed at an upper end of the shaft portion 71a. An annular groove 71c is also formed at a lower end portion of the shaft portion 71a. The hinge pin 71 is inserted downward from a swing hole 63a (see FIG. 7) of the upper hinge stay portion 63. Then, the hinge pin 71 is inserted into a swing shaft receiving member 44a, which is provided on the upper side of the front door 44.

The hinge pin 71 is also inserted into the swing shaft receiving member 44a, which is provided on the lower side of the front door 44. Furthermore, the hinge pin 71 is inserted into the swing hole 63a of the lower hinge stay portion 63. Then, on the lower side of the hinge pin 71, a circlip (a coming-off prevention member) 72 having a larger diameter than the swing hole 63a is fixed to a groove 71c. In this manner, the large-diameter portion 71b and the circlip 72 prevent the hinge pin 71 from coming off from the hinge bracket 60, and the front door 44 is supported to be swingable around the hinge pin 71.

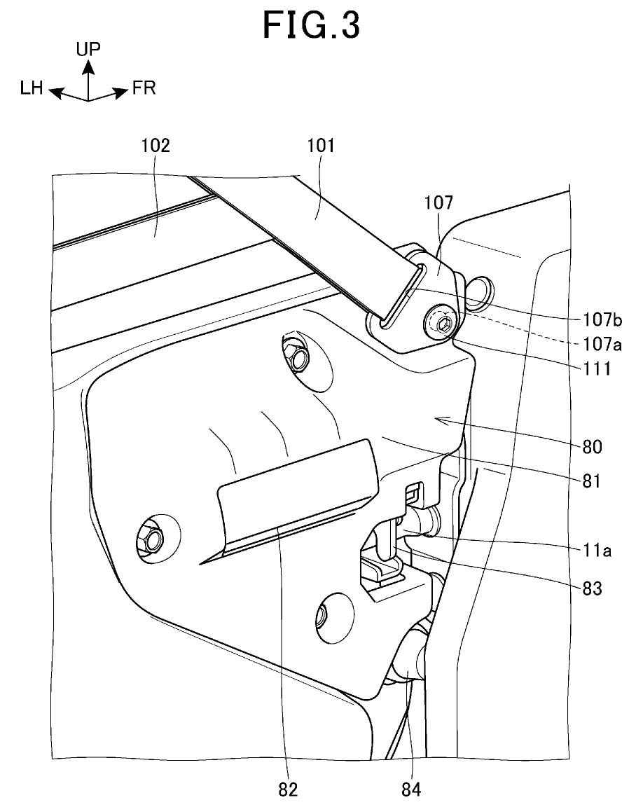

FIG. 3 is an explanatory view of an operation unit 80 of the left front door 44.

The operation unit 80 is provided on a vehicle body inner side surface at a front end portion of the front door 44. The operation unit 80 includes a housing 81, which has a cover shape that bulges inward in the vehicle width direction. An operation member 82 is rotatably supported by the housing 81. A latch 83, which rotates in conjunction with the operation member 82, is provided in a front portion of the operation member 82. When the front door 44 is closed, the latch 83 abuts and rides over a striker shaft 11a, which is provided on the vehicle body frame 11, and then engages with the striker shaft 11a to restrict opening of the front door 44.

An abutment 84 is supported below the latch 83. When the front door 44 is closed, the abutment 84 abuts the vehicle body frame 11 to restrict excessive swinging of the front door 44. When the operation member 82 is operated, the latch 83 rotates and releases the engagement with the striker shaft 11a. Thus, by pushing the front end portion of the front door 44 in a direction away from the vehicle body frame 11, the front door 44 swings around the hinge pin 71, and is opened.

According to the present embodiment, a door net 100 is provided on each of the pair of left and right front doors 44 as illustrated in FIG. 1. The door net 100 has a substantially triangular shape in a side view of the vehicle body. More specifically, the door net 100 according to the present embodiment has a shape in which an outer peripheral shape is defined by three belts 101, 102, and 103.

Specifically, the door net 100 includes: a first belt 101, which is inclined rearward and upward; a second belt 102, which extends in the front-rear direction; and a third belt 103, which extends in the up-down direction, in the side view of the vehicle body. The first belt 101 is connected at a front lower end with a front upper end portion of the front door 44, and is connected at a rear upper end with an upper end portion of the center pillar 28. The second belt 102 is connected at a front end with a lower end portion of the first belt 101, and is connected at a rear end with the hinge stay portion 63 of the hinge bracket 60 on the vehicle body frame 11 side. The third belt 103 is connected at an upper end with an upper end portion of the first belt 101, and is connected at a lower end with a rear end portion of the second belt 102.

These three belts 101 to 103 form a substantially triangular shape in the side view of the vehicle body. A net 106 is provided on the belts 101 to 103 so as to close a space among the belts 101 to 103. The belts 101 to 103 are connected with the front door 44 and the vehicle body frame 11 while keeping an appropriate tension. Accordingly, the door net 100 is provided in a stretched state above the front door 44, and a lateral side of the cabin space 30 is covered from the outside.

Here, the first belt 101 is coupled with the front door 44 via a mounting bracket (a door net attachment portion) 107. As illustrated in FIG. 3, the mounting bracket 107 has a tapered shape. A fixing hole 107a is formed on a tip end of the mounting bracket 107. A long hole 107b is formed on a base end side of the mounting bracket 107. The first belt 101 is inserted into the long hole 107b. Then, the first belt 101 that has been inserted is, for example, folded back to overlap the first belt 101 itself, and is fixed.

In this manner, the mounting bracket 107 is provided on the tip end of the first belt 101. A bolt (a fastener) 111, which extends in the left-right direction, is inserted into the fixing hole 107a of the mounting bracket 107. The bolt 111 is fixed to the housing 81 of the operation unit 80. The mounting bracket 107 is supported to be rotatable about the bolt 111.

Note that the first belt 101 is connected at a rear upper end with an upper portion of the center pillar 28 via a mounting bracket (the door net attachment portion) 109 (see FIG. 1).

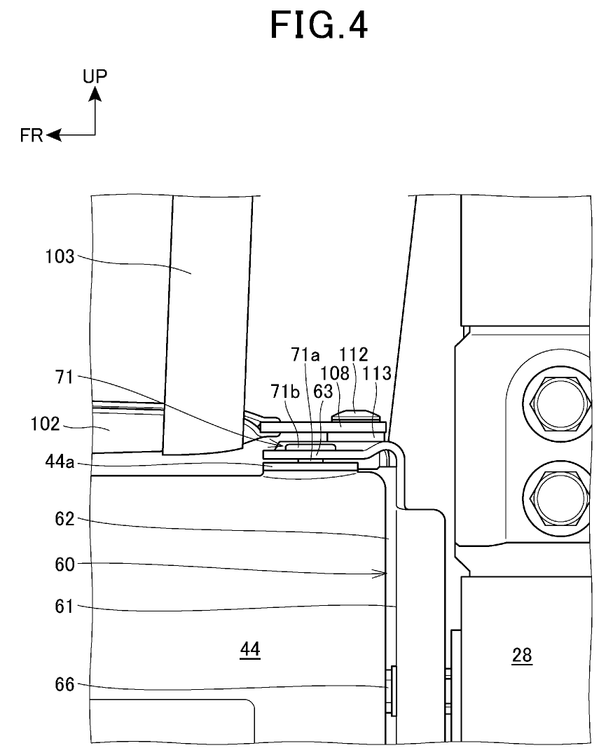

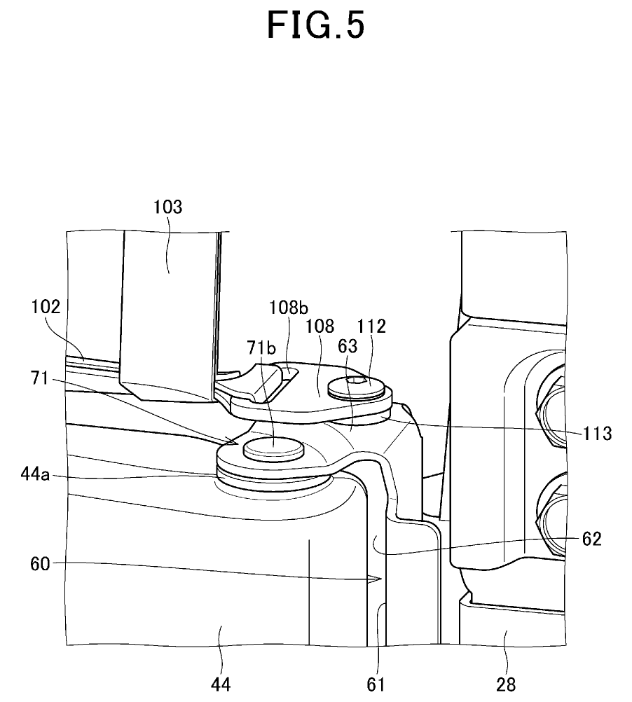

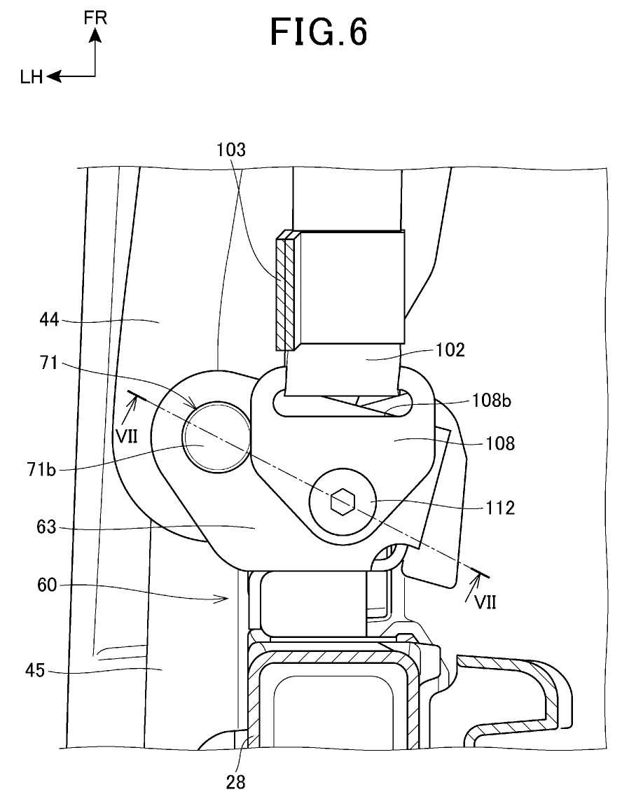

FIG. 4 is a left side view illustrating a peripheral portion of the hinge stay portion 63 on the upper side of the hinge bracket 60 according to the first embodiment. FIG. 5 is a perspective view of a peripheral portion of the hinge stay portion 63 on the upper side of the hinge bracket 60 according to the first embodiment when viewed from the left rear. FIG. 6 is a plan view illustrating a peripheral portion of the hinge stay portion 63 on the upper side of the hinge bracket 60 according to the first embodiment. FIG. 7 is a cross-sectional view taken along line VII-VII in FIG. 6.

The second belt 102 is coupled with the hinge bracket 60 via a mounting bracket (the door net attachment portion) 108. The mounting bracket 108 is formed in a similar manner to the mounting bracket 107. The configuration in which the mounting bracket 108 is provided on the second belt 102 is similar to the configuration in which the mounting bracket 107 is provided on the first belt 101.

In the hinge stay portion 63 on the upper side, a door net fastening portion 63b is formed on the inner side in the vehicle width direction and on the rear of the swing hole 63a (see FIGS. 6 and 7). The door net fastening portion 63b includes, for example, a welding nut. The mounting bracket 108 is coupled with the door net fastening portion 63b via a shoulder bolt 112. Specifically, the shoulder bolt 112 includes: a head portion 112a; a stepped portion 112b, which has a smaller diameter than the head portion 112a: and a threaded shaft portion 112c, which has a smaller diameter than the stepped portion 112b. The stepped portion 112b is inserted into a fixing hole 108a of the mounting bracket 108 and the hole of a washer 113, and the threaded shaft portion 112c is fastened to the door net fastening portion 63b. The shoulder bolt 112 is fastened to extend in parallel with the hinge pin 71.

The mounting bracket 108 is supported by the hinge stay portion 63 via the washer 113. The mounting bracket 108 is supported by the stepped portion 112b of the shoulder bolt 112. Thus, the mounting bracket 108 is swingable around the shoulder bolt 112.

In the irregular ground travel vehicle 10 according to the present embodiment, the operation member 82 is operated to unlock the front door 44. The door net 100 is supported by the front door 44, and thus the door net 100 is opened together with the front door 44. This eliminates the need for folding the door net 100 to open the cabin space 30, and enables the occupant to get in or out of the cabin space 30 only with an opening operation of the front door 44.

In addition, according to the present embodiment, the second belt 102 of the door net 100 is connected at a front end portion with the first belt 101, and is connected at a rear end portion with the hinge stay portion 63 of the hinge bracket 60. Thus, the second belt 102 extends with the swing center in swinging the front door 44 as the swing center, that is, a position close to the hinge pin 71 as the swing center, and is thus rotatable, while suppressing a change in its longitudinal length. Therefore, a change in tension and a change in shape caused by repeatedly opening the door net 100 are easily suppressed.

As described heretofore, according to the present embodiment, in the vehicle including: the vehicle body frame 11, which defines the cabin space 30; the hinge bracket 60, which is provided on the vehicle body frame 11; the front door 44, which is swingably supported by the vehicle body frame 11 via the hinge bracket 60; and the door net 100, which is attached to the vehicle body frame 11, and which covers the cabin space 30 from above the front door 44, the door net 100 has a substantially triangular shape in a vehicle side view, and includes the mounting brackets 107, 108, and 109, which are respectively provided at corner portions of the door net 100, and which are attached to the vehicle body, one of the three mounting brackets 107, 108, and 109 is attached to the front door 44, the remaining two of the three mounting brackets 107, 108, and 109 are swingably attached to the vehicle body frame 11, and one of the two mounting brackets 108 and 109, which are swingably attached to the vehicle body frame 11, is attached to the hinge bracket 60.

According to this configuration, the door net 100 is rotatable together with the front door 44 with the side attached to the vehicle body frame 11 as a swing center. In this situation, the swing center of the door net 100 can be provided so as not to be separated from the swing center of the front door 44. Therefore, according to this configuration, it becomes possible to provide the irregular ground travel vehicle 10 in which the door net 100 is provided so that the shape change hardly occurs, while getting in or out of the cabin space 30 is enabled with a simple operation.

According to the present embodiment, the hinge pin 71, which supports the front door 44 to be swingable, is provided. The mounting bracket 108, which is supported by the hinge bracket 60, is positioned on the inner side of the vehicle body than the hinge pin 71 of the front door 44 and on the rear of the hinge pin 71 of the front door 44 in a plan view.

According to this configuration, the swing center of the door net 100 is further separated from a swing open end of the front door 44, that is, a front end of the front door 44 than the swing center of the front door 44 according to the present embodiment. Therefore, when the front door 44 is swung and is opened and closed, the tension is appropriately applied to the door net 100 to easily stretch the door net. When the front door 44 is opened and closed, it becomes possible to integrally rotate the door net 100 together with the front door 44.

### Second Embodiment

A second embodiment will be described. In the second embodiment, parts configured in similar manners to the first embodiment are denoted by the same reference numerals, and their description will be omitted.

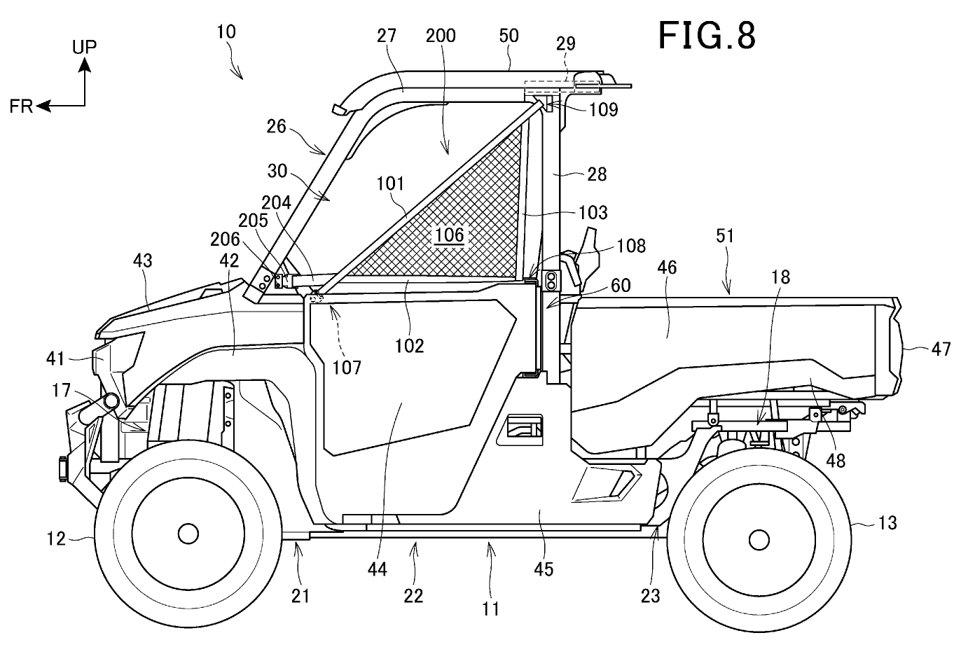

FIG. 8 is a left side view of an irregular ground travel vehicle 10 according to the second embodiment.

According to the second embodiment, a door net 200 is provided instead of the door net 100. The door net 200 according to the second embodiment is different from the door net 100 according to the first embodiment in that an extension belt 204 is provided on an extension on the front of the second belt 102.

A buckle (a fourth door net attachment portion) 205 is provided at a front end of the extension belt 204. The buckle 205 is detachably connected with a buckle 206, which is provided at a lower end portion of the front pillar 27 of the vehicle body frame 11.

According to the present embodiment, the front of the door net 200 is connected with the vehicle body frame 11 through the extension belt 204, and thus the door net 200 is more firmly supported by the vehicle body frame 11. In opening the front door 44, by detaching the buckle 205 from the buckle 206, the occupant is able to get in or out of the cabin space 30 only with an opening operation of the front door 44 in a similar manner to the first embodiment. Note that when the buckle 205 is not detached from the buckle 206, the front door 44 is not opened because the extension belt 204 is connected with the vehicle body frame 11. If firm fixing is not desired, even though the buckle 205 is used without being connected with the buckle 206, the door net 200 is supported by the mounting brackets 107 to 109, and is thus capable of functioning as the door net 200.

As described heretofore, according to the present embodiment, in a similar manner to the first embodiment, the door net 200 is rotatable together with the front door 44 with the side attached to the vehicle body frame 11 as the swing center. Therefore, also in the present embodiment, it becomes possible to provide the irregular ground travel vehicle 10 in which the door net 200 is provided so that the shape change hardly occurs, while getting in or out of the cabin space 30 is enabled with a simple operation.

In particular, according to the present embodiment, the door net 200 includes the buckle 205, which is attachable to and detachable from the vehicle body frame 11 via the buckle 206, at a tip end portion of the door net 200.

According to this configuration, if desired to firmly attach the door net 200, it becomes possible to firmly attach the door net to the vehicle body frame 11 using the buckle 205.

### Third Embodiment

A third embodiment will be described. In the third embodiment, parts configured in similar manners to those in the first and second embodiments are denoted by the same reference signs, and their description will be omitted.

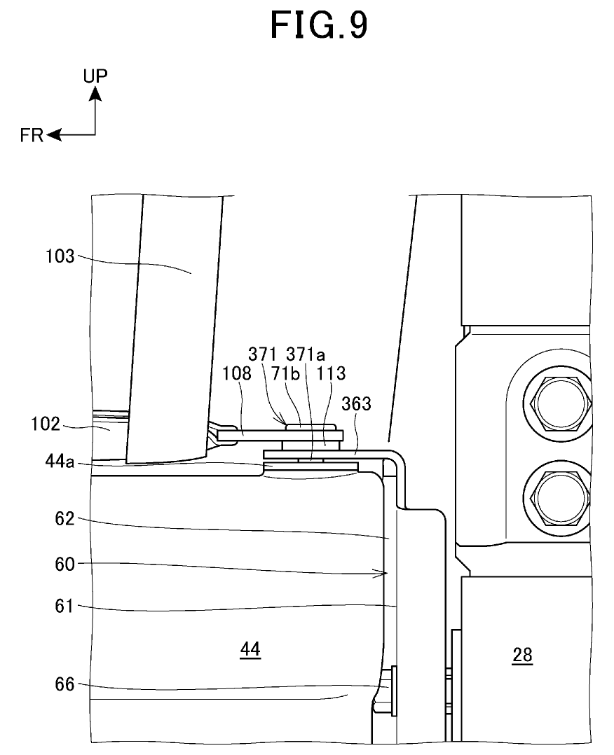

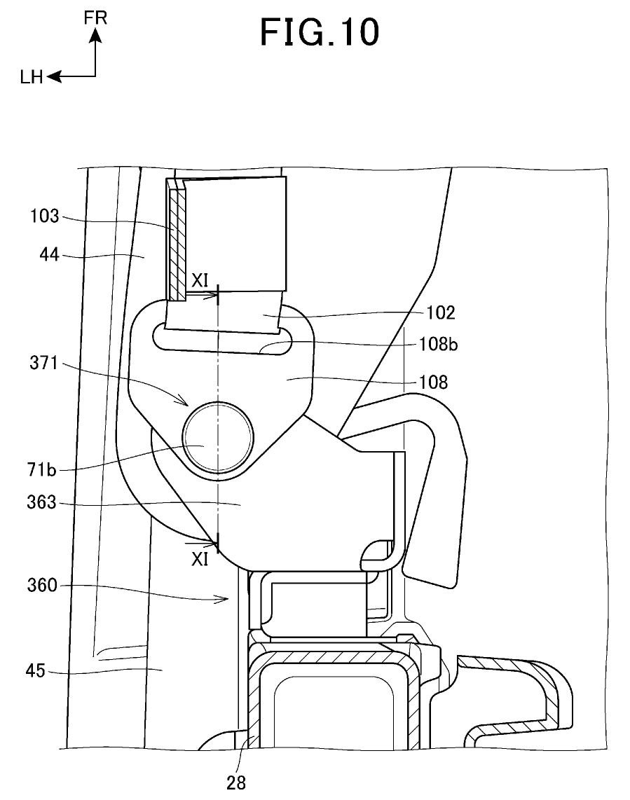

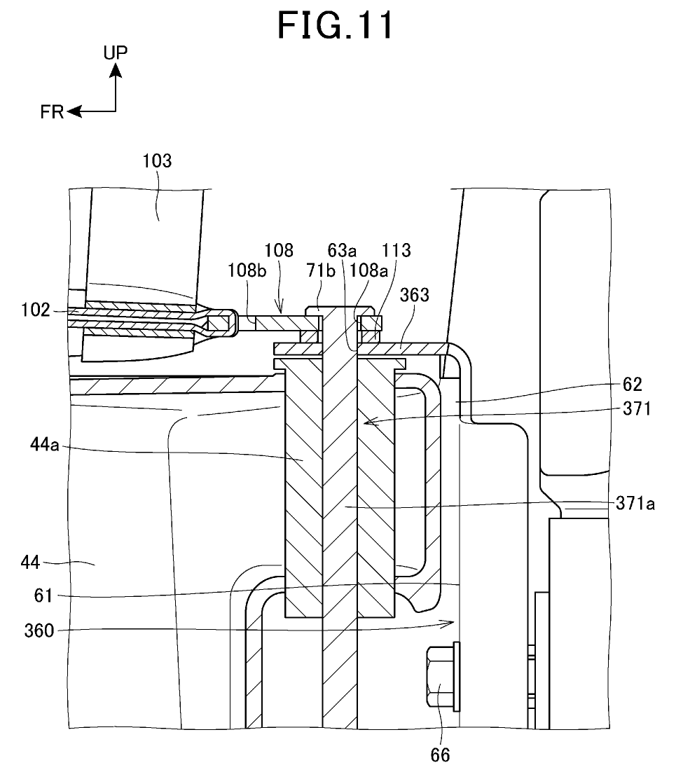

FIG. 9 is a left side view illustrating a peripheral portion of a hinge stay portion 363 on an upper side of a hinge bracket 360 according to the third embodiment. FIG. 10 is a plan view illustrating the peripheral portion of the hinge stay portion 363 on the upper side of the hinge bracket 360 according to the third embodiment. FIG. 11 is a cross-sectional view taken along line XI-XI in FIG. 10.

The hinge bracket 360 according to the third embodiment is different from the hinge bracket 60 according to the first embodiment in that the door net fastening portion 63b is omitted in the hinge stay portion 363 on the upper side.

According to the third embodiment, a hinge pin (a swing shaft) 371 is different from the hinge pin 71 according to the first embodiment in that the length of a shaft portion 371a is longer than the length of the shaft portion 71a.

According to the third embodiment, the hinge pin 371 is inserted through the mounting bracket 108 and the washer 113.

Accordingly, the swing center of the mounting bracket 108 coincides with the swing center of the front door 44, and thus it becomes possible to make it difficult to cause the tension change of the second belt 102 particularly when the front door 44 is swung, so that deformation of the door net 100 is easily suppressed.

As described heretofore, according to the present embodiment, in a similar manner to the first and second embodiments, the door net 100 is rotatable together with the front door 44 with the side attached to the vehicle body frame 11 as the swing center. Therefore, also in the present embodiment, it becomes possible to provide the irregular ground travel vehicle 10 in which the door net 100 is provided so that the shape change hardly occurs, while getting in or out of the cabin space 30 is enabled with a simple operation.

In particular, according to the present embodiment, the hinge pin 371, which supports the front door 44 to be swingable, is provided, and the mounting bracket 108, which is supported by the hinge bracket 360, is supported coaxially with the hinge pin 371.

According to this configuration, the swing center of the door net 100 can be easily aligned with the hinge pin 371 of the front door 44, so that the door net 100 can be swung together with the front door 44 while a shape change of the door net 100 hardly occurs.

### Fourth Embodiment

A fourth embodiment will be described. In the fourth embodiment, parts configured in similar manners to those in the first to third embodiments are denoted by the same reference signs, and their description will be omitted.

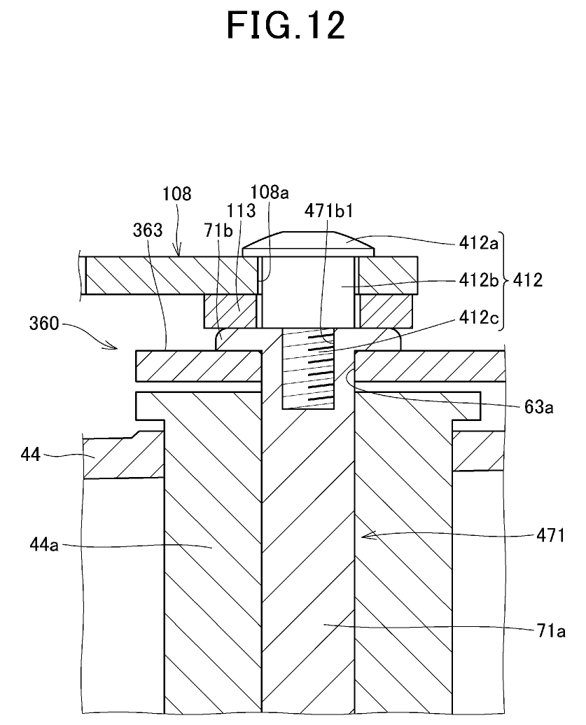

FIG. 12 is a cross-sectional view schematically illustrating a peripheral portion of the hinge stay portion 363 on the upper side of the hinge bracket 360 according to the fourth embodiment.

In the fourth embodiment, a hinge pin (a swing shaft) 471 is provided instead of the hinge pin 371 according to the third embodiment. The hinge pin 471 according to the fourth embodiment is configured in a substantially similar manner to the hinge pin 71 according to the first embodiment. However, the hinge pin 471 according to the fourth embodiment is different from the hinge pin 71 according to the first embodiment in that a fastening hole portion 471b is formed in the large-diameter portion 71b. The center line of the fastening hole portion 471b is aligned with the center line of the shaft portion 71a.

A shoulder bolt (an attachment portion support portion) 412 is fastened to the fastening hole portion 471b. The shoulder bolt 412 can be configured in a similar manner to the shoulder bolt 112 according to the second embodiment. The shoulder bolt 412 includes a head portion 412a, a stepped portion 412b, and a threaded shaft portion 412c. The mounting bracket 108 and the washer 113 are attached to the stepped portion 412b of the shoulder bolt 412.

As described heretofore, similarly to the first to third embodiments, the door net 100 is rotatable together with the front door 44 with the side attached to the vehicle body frame 11 as the swing center. Therefore, also in the present embodiment, it becomes possible to provide the irregular ground travel vehicle 10 in which the door net 100 is provided so that the shape change hardly occurs, while getting in or out of the cabin space 30 is enabled with a simple operation.

In addition, according to the present embodiment, in a similar manner to the third embodiment, the mounting bracket 108, which is supported by the hinge bracket 360, is supported coaxially with the hinge pin 471. Therefore, also in the present embodiment, the door net 100 can be swung together with the front door 44 while a shape change of the door net 100 hardly occurs.

In particular, according to the present embodiment, the shoulder bolt 412, which supports the mounting bracket 108, is provided on an upper portion of the hinge pin 471.

According to this configuration, after the hinge pin 471 of the front door 44 is assembled, it becomes possible to provide the mounting bracket 108 on the hinge pin 471, so that the degree of freedom in assembling performance is obtainable.

### Fifth Embodiment

A fifth embodiment will be described. In the fifth embodiment, parts configured in similar manners to those in the first to fourth embodiments are denoted by the same reference signs, and their description will be omitted.

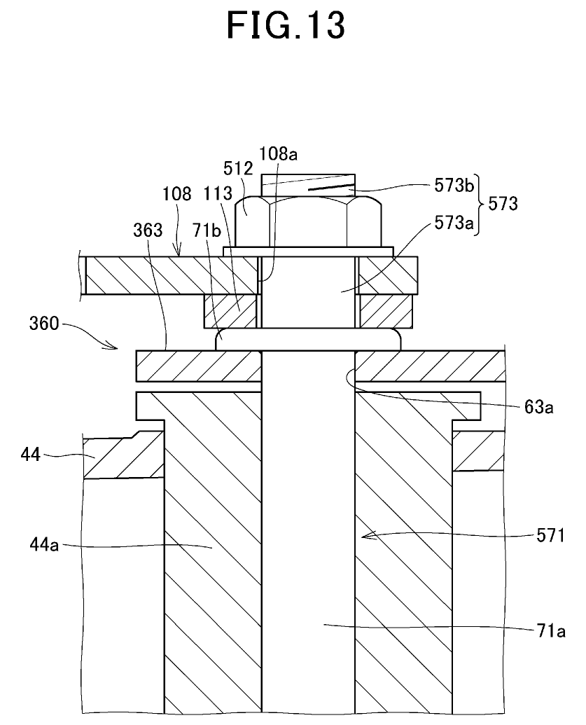

FIG. 13 is a cross-sectional view schematically illustrating a peripheral portion of the hinge stay portion 363 on the upper side of the hinge bracket 360 according to the fifth embodiment.

According to the fifth embodiment, a hinge pin (a swing shaft) 571 is provided instead of the hinge pin 471 according to the fourth embodiment. The hinge pin 571 according to the fifth embodiment is configured in a substantially similar manner to the hinge pin 71 according to the first embodiment. However, the hinge pin 571 according to the fifth embodiment is different from the hinge pin 71 according to the first embodiment in that a support pin portion (an attachment portion support portion) 573, which protrudes upward from the large-diameter portion 71b, is provided.

The support pin portion 573 is formed coaxially with the shaft portion 71a. The support pin portion 573 includes: a columnar portion 573a on a lower side; and a threaded portion 573b, which is provided on an upper side of the columnar portion 573a. The mounting bracket 108 and the washer 113 are attached to the columnar portion 573a. Then, a nut 512 is fastened to the threaded portion 573b. Therefore, the mounting bracket 108 of the door net 100 is supported coaxially with the hinge pin 571.

As described heretofore, in a similar manner to the first to fourth embodiments, the door net 100 is rotatable together with the front door 44 with the side attached to the vehicle body frame 11 as the swing center. Therefore, also in the present embodiment, it becomes possible to provide the irregular ground travel vehicle 10 in which the door net 100 is provided so that the shape change hardly occurs, while getting in or out of the cabin space 30 is enabled with a simple operation.

In addition, according to the present embodiment, in a similar manner to the third and fourth embodiments, the mounting bracket 108, which is supported by the hinge bracket 360, is supported coaxially with the hinge pin 571. Therefore, also in the present embodiment, the door net 100 can be swung together with the front door 44 while a shape change of the door net 100 hardly occurs.

In particular, according to the present embodiment, the support pin portion 573, which supports the mounting bracket 108, is provided on the upper portion of the hinge pin 571.

According to this configuration, after the hinge pin 571 of the front door 44 is assembled, it becomes possible to provide the mounting bracket 108 on the hinge pin 571, so that the degree of freedom in assembling performance is obtainable.

### Other Embodiments

The above-described embodiments merely describe one aspect of the present invention, and can be optionally modified and applied without departing from the gist of the present invention.

In the above embodiments, the MUV including the pair of left and right front wheels 12 and the pair of left and right rear wheels 13 has been described as an example of the irregular ground travel vehicle 10. However, one rear wheel 13 may be applicable, and a so-called tricycle may be used as the vehicle.

In the above third to fifth embodiments, the configuration including the door net 100 has been described, but the door net 200 may be provided instead of the door net 100.

### Configuration Supported by The Above Embodiments

The above embodiments support the following configurations.

(Configuration 1) A vehicle including: a vehicle body frame that defines a cabin space; a hinge bracket provided on the vehicle body frame; a door swingably supported by the vehicle body frame via the hinge bracket; and a door net, which is attached to the vehicle body frame, and which covers the cabin space from above the door, in which the door net has a substantially triangular shape in a vehicle side view, and includes three door net attachment portions, which are respectively provided at corner portions of the door net, and which are attached to a vehicle body, one of the three door net attachment portions is attached to the door, and remaining two door net attachment portions of the three door net attachment portions are swingably attached to the vehicle body frame, and one of the remaining two door net attachment portions swingably attached to the vehicle body frame is attached to the hinge bracket.

According to this configuration, the door net is rotatable together with the door with the side attached to the vehicle body frame as the swing center. In this situation, it becomes possible to provide the swing center of the door net so as not to be separated from the swing center of the door, and thus it becomes possible to provide a vehicle in which the door net is provided so that a shape change hardly occurs, while getting in or out of the cabin space is enabled with a simple operation.

(Configuration 2) The vehicle described in the configuration 1, further includes a swing shaft, which supports the door to be swingable, in which the door net attachment portion supported by the hinge bracket is positioned on an inner side of a vehicle body than the swing shaft of the door and on rear of the swing shaft of the door in a plan view.

According to this configuration, the swing center of the door net is further separated from the swing open end of the door than the swing center of the door. Therefore, when the door is swung and is opened and closed, the tension is appropriately applied to the door net to easily stretch the door net, and when the door is opened and closed, it becomes possible to integrally rotate the door net together with the door.

(Configuration 3) The vehicle described in the configuration 1, further includes a swing shaft, which supports the door to be swingable, in which the door net attachment portion supported by the hinge bracket is supported coaxially with the swing shaft.

According to this configuration, the swing center of the door net can be easily aligned with the swing shaft of the door, so that the door net can be swung together with the door while a shape change of the door net hardly occurs.

(Configuration 4) The vehicle described in the configuration 3, in which an attachment portion support portion, which supports the door net attachment portion, is provided in an upper portion of the swing shaft.

According to this configuration, after the swing shaft of the door is assembled, it becomes possible to provide the door net attachment portion on the swing shaft, so that the degree of freedom in assembling performance is obtainable.

(Configuration 5) The vehicle described in one of the configurations 1 to 4, in which the door net includes, at a tip end portion of the door net, a fourth door net attachment portion attachable to and detachable from the vehicle body frame via a buckle.

According to this configuration, if desired to firmly attach the door net, it becomes possible to firmly attach the door net to the vehicle body frame.

### REFERENCE SIGNS LIST

10 Irregular ground travel vehicle (vehicle)

11 Vehicle body frame

30 Cabin space

44 Front door (door)

60 Hinge bracket

71 Hinge pin (swing shaft)

100 Door net

107 Mounting bracket (door net attachment portion)

108 Mounting bracket (door net attachment portion)

109 Mounting bracket (door net attachment portion)

200 Door net

205 Buckle (fourth door net attachment portion)

206 Buckle

360 Hinge bracket

371 Hinge pin (swing shaft)

412 Shoulder bolt (attachment portion support portion)

471 Hinge pin (swing shaft)

571 Hinge pin (swing shaft)

573 Support pin portion (attachment portion support portion)

What is claimed is:

1. A vehicle comprising:
a vehicle body frame that defines a cabin space;
a hinge bracket provided on the vehicle body frame;
a door swingably supported by the vehicle body frame via the hinge bracket; and
a door net, which is attached to the vehicle body frame, and which covers the cabin space from above the door, wherein
the door net has a substantially triangular shape in a vehicle side view, and includes three door net attachment portions, which are respectively provided at corner portions of the door net, and which are attached to a vehicle body,
one of the three door net attachment portions is attached to the door, and remaining two door net attachment portions of the three door net attachment portions are swingably attached to the vehicle body frame, and
one of the remaining two door net attachment portions swingably attached to the vehicle body frame is attached to the hinge bracket.

2. The vehicle according to claim 1, further comprising
a swing shaft, which supports the door to be swingable, wherein
the door net attachment portion supported by the hinge bracket is positioned on an inner side of a vehicle body than the swing shaft of the door and on rear of the swing shaft of the door in a plan view.

3. The vehicle according to claim 1, further comprising
a swing shaft, which supports the door to be swingable, wherein
the door net attachment portion supported by the hinge bracket is supported coaxially with the swing shaft.

4. The vehicle according to claim 3, wherein
an attachment portion support portion, which supports the door net attachment portion, is provided in an upper portion of the swing shaft.

5. The vehicle according to claim 1, wherein
the door net includes, at a tip end portion of the door net, a fourth door net attachment portion attachable to and detachable from the vehicle body frame via a buckle.
